(19) United States
(12) Patent Application Publication
(10) Pub. No.: US 2016/0014181 A1
(43) Pub. Date: Jan. 14, 2016

(54) CONTENT TRANSFER METHOD, CONTENT TRANSFER APPARATUS AND CONTENT RECEIVING APPARATUS

(71) Applicant: FUJITSU LIMITED, Kawasaki-shi (JP)

(72) Inventor: AKIRA TAKAMUNE, Kawasaki (JP)

(21) Appl. No.: 14/792,132

(22) Filed: Jul. 6, 2015

(30) Foreign Application Priority Data
Jul. 8, 2014 (JP) 2014-140534

(51) Int. Cl. H04L 29/06

(52) U.S. Cl. CPC H04L 65/607; H04L 65/4069

(57) ABSTRACT

A content transfer method of transferring content from a server to a client, the content transfer method comprising transmitting, by the server, to the client a list indicating a type of content which can be transferred to the client, the list including a type of content in which a bit rate used for encoding the content can be changed within a predetermined range, encoding, by the server, the content using a bit rate within the predetermined range indicated in the list specified by the client during the transferring of the content to the client, the specified bit rate being used as an upper limit of the bit rate used for encoding the content, and transferring, by the server, the encoded content to the client.

### CROSS-REFERENCE TO RELATED APPLICATION

This application is based upon and claims the benefit of priority of the prior Japanese Patent Application No. 2014-140534, filed on Jul. 8, 2014, the entire contents of which are incorporated herein by reference.

### FIELD

The embodiments discussed herein are related to a content transfer method for streaming, a content transfer apparatus therefor and a content receiving apparatus therefor.

### BACKGROUND

Recently, devices compliant with DLNA (Digital Living Network Alliance) guideline are used to allow users to access to video image data stored in recorders etc. in users' premises by using Internet from client terminals outside the premises. With this technique, streaming of the video image data can be achieved outside the premises. Therefore, communication providers, that is, carriers are developing video image distribution services compliant with the DLNA guideline.

Data including video image, still image, music content etc. can be supported under DLNA. Services compliant with DLNA guideline can be achieved by connecting clients called DMP (Digital Media Player) and servers called DMS (Digital Media Server). Users can use DMP to play data including video image, still image, music content etc. stored in DMS via network. Information called multi-resource in which a plurality of resources are attached to a content is transmitted under DLNA guideline when the resource information of the content stored in DMS transmitted to DMP. Therefore, DMP can select a content of each resource according to the performance of the terminal to play the content.

Currently, communication providers sets an upper limit for users as subscribers on the amount of packet communication available in one month. Therefore, the communication speed available to a user can be limited when the user is receiving a streaming service using DLNA and the amount of packet communication exceeds the upper limit. For example, the user cannot use high-speed communications such as LTE (Long Term Evolution) due to the communication speed limit. As a result, the communication speed may be reduced to 128 kbps, for example. Under these circumstances, techniques are proposed for adjusting the amount of packet communication not to exceed the upper limit when the user is receiving the streaming service by changing the contents transferred to a client used by the user in accordance with the amount of packet communication for the client or the user's actions during the streaming (see patent documents 1 to 3 below).

The following patent document describes conventional techniques related to the techniques described herein.

### PATENT DOCUMENT

[Patent document 1] Japanese Patent No. 5180368

[Patent document 2] Japanese Patent Application Laid-Open Publication No. 2010-258940

[Patent document 3] Japanese Patent Application Laid-Open Publication No. 2008-263412

### SUMMARY

According to one embodiment, it is provided a content transfer method of transferring content from a server to a client, the content transfer method comprising transmitting, by the server, to the client a list indicating a type of content which can be transferred to the client, the list including a type of content in which a bit rate used for encoding the content can be changed within a predetermined range, encoding, by the server, the content using a bit rate within the predetermined range indicated in the list specified by the client during the transferring of the content to the client, the specified bit rate being used as an upper limit of the bit rate used for encoding the content, and transferring, by the server, the encoded content to the client.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating a configuration of a streaming system according to an embodiment;

FIG. 2 is a diagram schematically illustrating a hardware configuration of a server apparatus according to an embodiment;

FIG. 3 is a diagram schematically illustrating a hardware configuration of a client apparatus according to an embodiment;

FIG. 4A is a functional diagram illustrating functional units of a client apparatus according to an embodiment;

FIG. 4B is a functional diagram illustrating functional units of a server apparatus according to an embodiment;

FIG. 5A is a graph illustrating a temporal transition of bit rate in encoding by constant bit rate (CBR);

FIG. 5B is a graph illustrating a temporal transition of bit rate in encoding by variable bit rate (VBR);

FIG. 6 is a diagram illustrating an example of a content list according to an embodiment;

FIG. 7 is a sequence diagram illustrating processes performed by a server apparatus and a client apparatus according to an embodiment;

FIG. 8 is a flowchart illustrating processes performed by a client apparatus according to an embodiment;

FIG. 9 is a graph illustrating a transition of the amount of packet communication of a client apparatus according to an embodiment;

FIG. 10 is a sequence diagram illustrating processes performed by a server apparatus and a client apparatus according to a variation example; and

FIG. 11 is a flowchart illustrating processes performed by a client apparatus according to a variation example.

### DESCRIPTION OF EMBODIMENTS

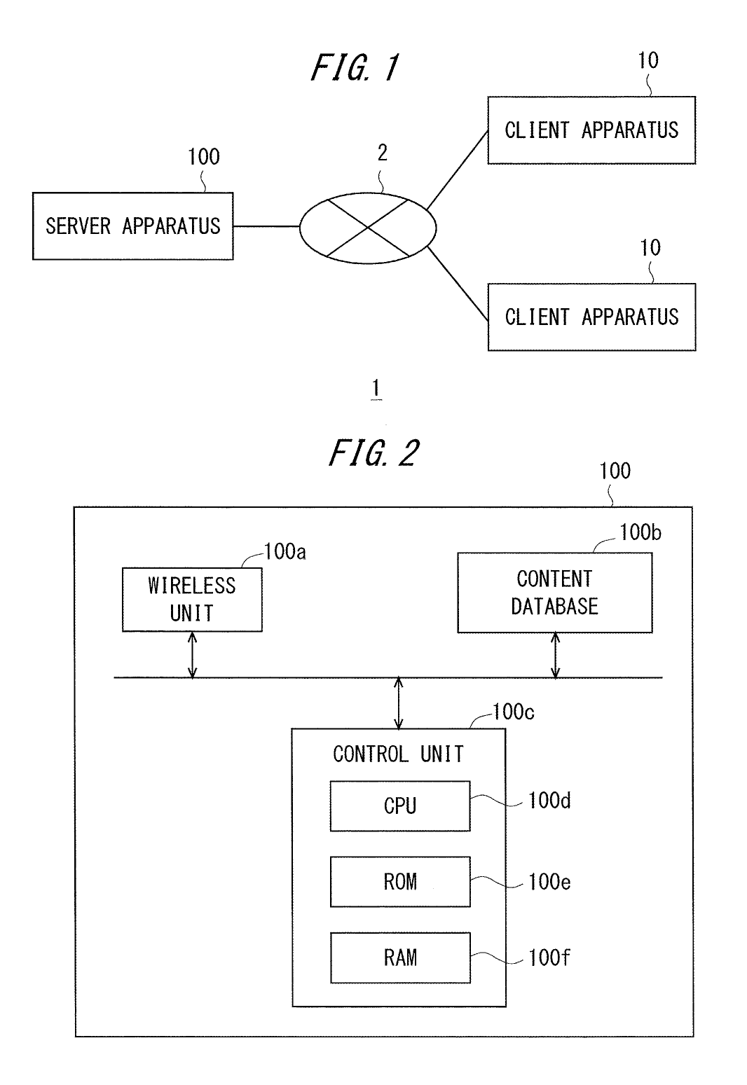

DMP switches the resource of the content to be played from a high-definition content to a low-definition content in the technique as described above. Since the multi-resource information is transmitted by DMP, DMP can acquire a content in which the resolution and the bit rate of the content are changed according to the content type. However, DMP acquires the content data used after the switching on HTTP again. Therefore, a black screen is displayed or sound is not output on the DMP between the change of the content type and the play of the changed content. One aspect of the present invention lies in providing a technology capable of continuing the display of content at the client side at the time when the client is streaming the content and the type of the content which can be transferred to the client is changed. First, a content transfer method according to one embodiment is described below with reference to the drawings. A streaming system 1 as illustrated in FIG. 1 is described as an example in the present embodiment. A configuration of the following embodiment is an exemplification, and the present apparatus is not limited to the configuration of the embodiment.

As illustrated in FIG. 1, a plurality of client apparatuses 10 are connected with a server apparatus 100 via a network 2 in the streaming system 1 according to the present embodiment. Although two client apparatuses 10 are depicted in FIG. 1, the number of client apparatuses 10 is not limited to two. In addition, each client apparatus 10 employs the following configurations.

FIG. 2 illustrates a configuration of the server apparatus 100. As illustrated in FIG. 2, the server apparatus 100 includes a wireless unit 100a, a content database 100b and a control unit 100c. The server apparatus 100 corresponds to an example of a content transfer apparatus. The wireless unit 100a transmits data to and receives data from the client apparatuses 10 via the network 2 through wireless communication. The content database 100b stores content data for streaming played by the client apparatuses 10. The control unit 100c includes a CPU (Central Processing Unit) 100d, ROM (Read Only Memory) 100e and RAM (Random Access Memory) 100f. The CPU 100d deploys a variety of applications stored in the ROM 100e onto the RAM 100f and executes the deployed applications to perform a variety of processes for transmitting content stored in the content database 100b to the client apparatuses 10. The detailed processes performed by the control unit 100c are described later.

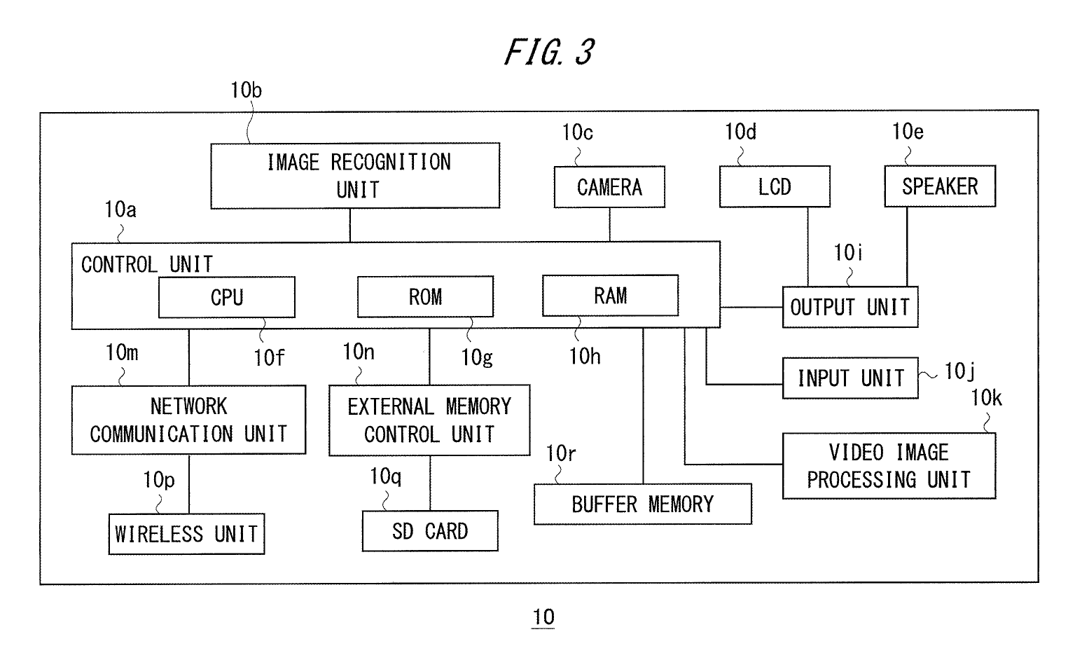

FIG. 3 illustrates a configuration of the client apparatus 10. As illustrated in FIG. 3, the client apparatus 10 includes a control unit 10a, an image recognition unit 10b, a camera 10c, an LCD (Liquid Crystal Display) 10d, a speaker 10e, an output unit 10i, an input unit 10j, a video image processing unit 10k, a network communication unit 10m, an external memory control unit 10n, a wireless unit 10p, an SD (Secure Digital) card 10q and buffer memory 10r. It is noted that the client apparatus 10 corresponds to an example of a content receiving apparatus.

The control unit 10a includes a CPU 10f, ROM 10g and RAM 10h. The CPU 10f reads out programs stored in the ROM 10g and deploys the programs onto the RAM 10h to perform a variety of control processes using data stored in the ROM 10g. In addition, the control unit 10a receives operation instructions from the user of the client apparatus 10 via the input unit 10j and performs processes in accordance with the operation instructions. Further, the control unit 10a uses the network communication unit 10m and the wireless unit 10p to perform the wireless communication with the server apparatus 100. The control unit 10a performs streaming of the content data received from the server apparatus 100 via the wireless unit 10p and the network communication unit 10m.

The control unit 10a sends the received streaming content to the video image processing unit 10k. The video image processing unit 10k performs decoding processes and analyzing processes of the content received from the control unit 10a. The content processed by the video image processing unit 10k is sent to the control unit 10a. The control unit 10a sends the video image data and the audio data of the content to the LCD 10d and the speaker 10e via the output unit 10i, respectively. And the playing of the content is performed by displaying the video image of the content on the LCD 10a and outputting the audio of the content from the speaker 10e.

In the present embodiment, the control unit 10a stores the content information including the title, the resolution, the bit rate, the playing position etc. in the ROM 10g when the streaming is ceased. The control unit 10a reads out data stored in the ROM 10g as appropriate to restart the ceased streaming when the control unit 10a performs the playing of the content next time. It is noted that the control unit 10a can send the variety of data used in the processes performed in the present embodiment to the SD card 10q inserted into a slot (not illustrated) of the client apparatus 10 via the external memory control unit 10n as appropriate to store the data in the SD card 10q.

In addition, the control unit 10a executes a program stored in the ROM 10g to acquire information of the amount of packet communication of the client apparatus 10 via the network communication unit 10m. Further, the control unit 10a activates the camera 10c to acquire the face image of the user of the client apparatus 10 from the camera 10c when the user plays the content on the client apparatus 10. Moreover, the control unit 10a sends the acquired face image of the user to the image recognition unit 10b. The image recognition unit 10b uses the received face image of the user to determine whether or not the user is currently watching the LCD 10d. And the control unit 10a uses the determination of the image recognition unit 10b to perform processes for controlling the quality of the content the streaming of which is being performed. The details of the processes are described later.

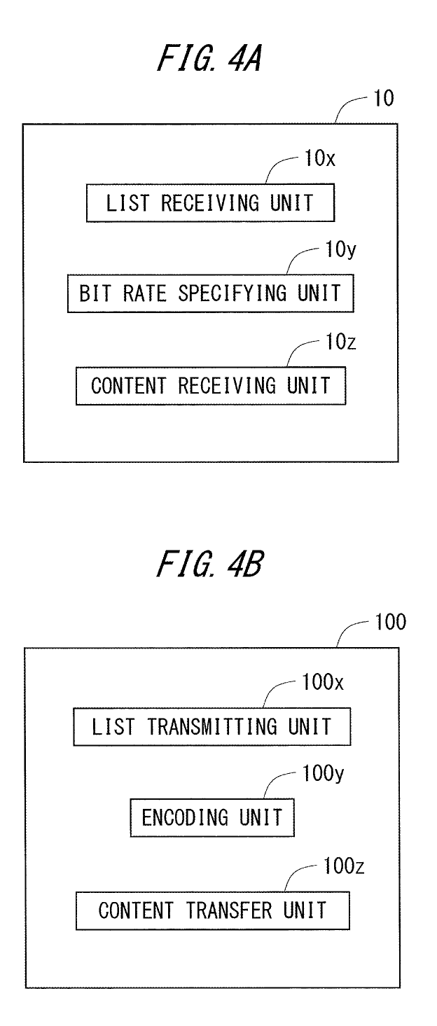

The client apparatus 10 functions as a list receiving unit 10x, a bit rate specifying unit 10y and a content receiving unit 10z as illustrated in FIG. 4A when the CPU 10f of the client apparatus 10 reads out programs from the ROM 10g and deploys the programs onto the RAM 10h to execute the programs.

Also, the server apparatus 100 functions as a list transmitting unit 100x, an encoding unit 100y and a content transfer unit 100z as illustrated in FIG. 4B when the CPU 100d of the server apparatus 100 reads out programs from the ROM 100e and deploys the programs onto the RAM 100f to execute the programs.

The list receiving unit 10x receives the list as described above transmitted from the list transmitting unit 100x. The bit rate specifying unit 10y specifies a bit rate within a predetermined range as indicated in the list for the server apparatus 100 while the content is being transmitted. The content receiving unit 10z receives from the server apparatus 100 the content which has been encoded with the bit rate specified as the upper limit of bit rate allowed for encoding the content.

The list transmitting unit 100x transmits to the client apparatus 10 a list of types of content which can be transferred. The list includes a type of content for which the bit rate set for the encoding can be changed within a predetermined range. The type is referred to as dynamic alteration image. When the server apparatus 100 is transmitting content and the client apparatus 10 specifies a bit rate within the predetermined range indicated in the list, the encoding unit 100y resets the specified bit rate to encode the content. The content transfer unit 100z transfers the encoded content to the client apparatus 10.

It is noted that the processes performed by the CPU 10f and 100d are not necessarily allocated as described above. In addition, at least a part of processes performed by more than one of the list receiving unit 10x, the bit rate specifying unit 10y, the content receiving unit 10z, the list transmitting unit 100x, the encoding unit 100y and the content transfer unit 100z can be performed by a hardware circuit.

The methods of encoding the streaming content includes a method called CBR (Constant Bit Rate) and a method called VBR (Variable Bit Rate). When CBR is employed, the encoding is performed with a constant bit rate at the time of playing of the content. On the other hand, when VBR is employed, the bit rate is changed according to the variation of the amount of audio and image data. Generally, a bit rate called average bit rate is specified, and the amount of data is modulated by, for example, increasing the conversion efficiency of data to reduce the amount of data when the amount of data increases to achieve the average bit rate. For example, the bit rate is set to a higher rate when a fast-moving scene is played whereas the bit rate is set to a lower rate when a scene in which almost no motion exists is played. Thus, the quality of the video streaming can be maintained by flexibly changing the bit rate.

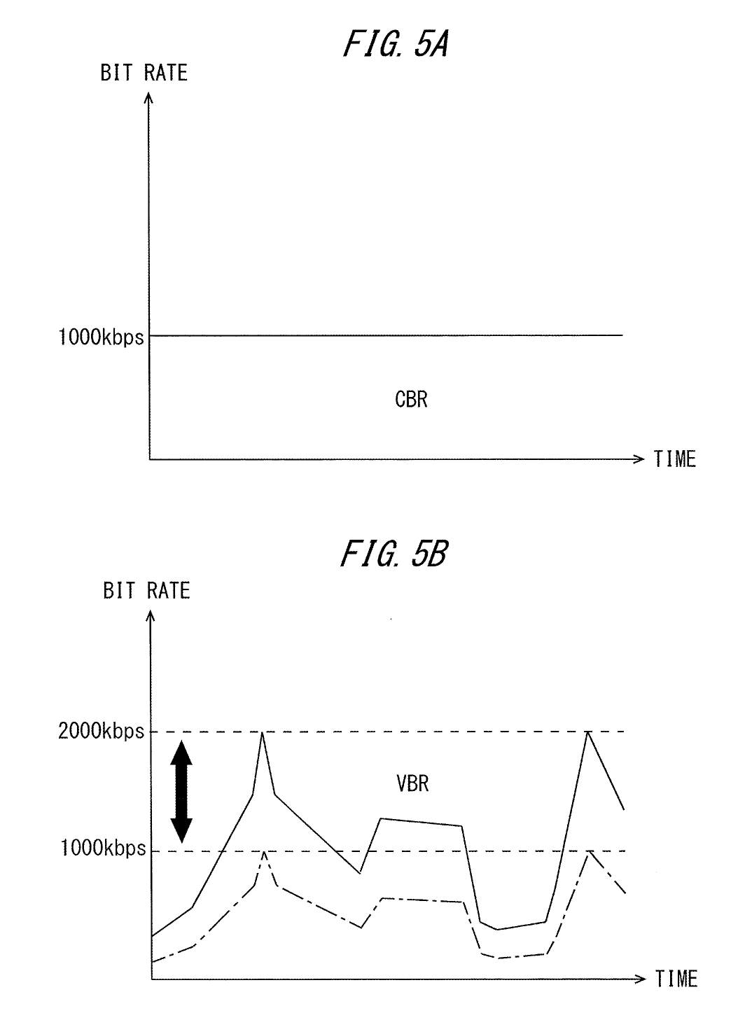

FIGS. 5A and 5B illustrate examples of the time variations of bit rates in a case in which the video streaming is performed with CBR and in a case in which the video streaming is performed with VBR, respectively. As illustrated in FIG. 5A, the data to be transferred is compressed using a constant bit rate when CBR is employed. When CBR is employed, the bit rate is not changed according to the sound and image of the content. Therefore, when the video is played and the sound becomes intense or the scene becomes fast-moving, the sound can become noisy and strobing can occur in the scene. As a result, the video quality can be decreased since the bit rate is constant when CBR is employed.

On the other hand, when VBR is employed, the bit rate can be changed according to the audio and video data to be played. For example, the bit rate is decreased when a silent pause occurs or a black screen is displayed whereas the bit rate is increased when an intense sound is played or fast-moving scene is displayed. Therefore, data can be transferred to the client apparatus 10 with the increased bit rate when the streaming data includes a part in which the variation is intense. Therefore, the client apparatus 10 can maintain the image quality and the sound quality to play the data.

In addition, the client apparatus 10 specifies a bit rate for encoding the content using VBR to the server apparatus 100. Thus, the client apparatus 10 coordinates the size of the content transferred from the server apparatus 100. For example, when the bit rate set to an encoder of the content is 2 Mbps in the server apparatus 100, the bit rate can be changed to 1 Mbps according to a specification from the client apparatus 10. In this case, the server apparatus 100 changes the upper limit for the bit rate from 2 Mbps to 1 Mbps, encodes the content and transmits the encoded content to the client apparatus 10 as illustrated by the dashed-line graph in FIG. 5B. Similarly, when the bit rate is changed from 1 Mbps to 2 Mbps, the server apparatus 100 changes the upper limit for the bit rate from 1 Mbps to 2 Mbps, encodes the content and transmits the encoded content to the client apparatus 10 as illustrated by the solid-line graph in FIG. 5B.

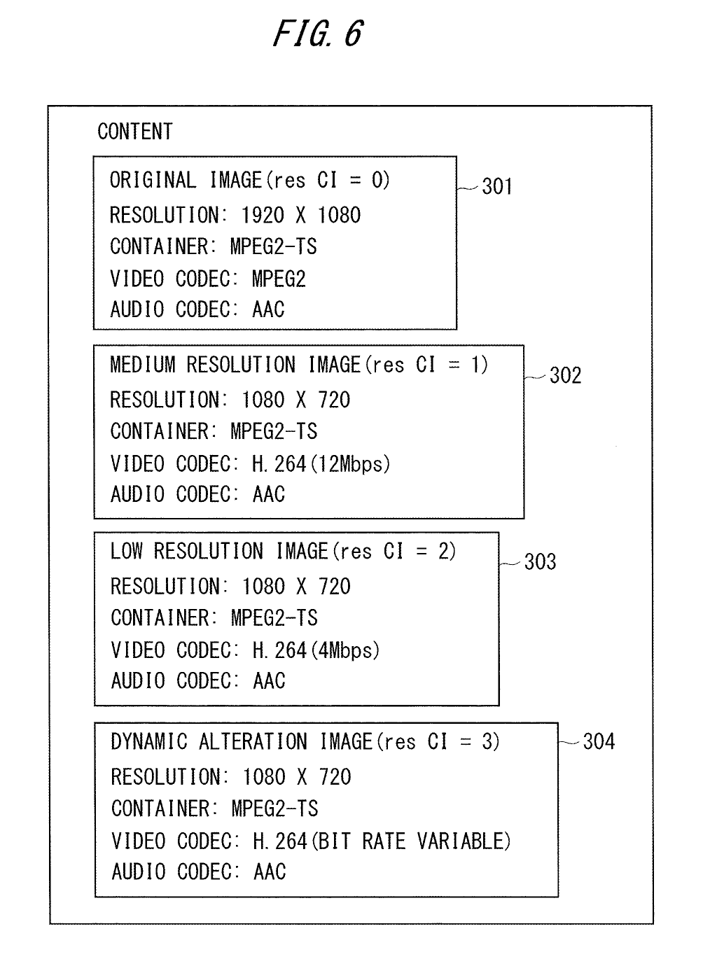

FIG. 6 is a diagram illustrating a summary of each image type used in the present embodiment. The server apparatus 10 employs a technique called multi-resource to generate images for streaming and transfers the generated images to the client apparatus 10. Specifically, the server apparatus 100 can transfer each type of image including the original image 301, the medium resolution image 302, the low resolution image 303 and the dynamic alteration image 304 to the client apparatus 10 as illustrated in FIG. 6.

The server apparatus 100 transmits to the client apparatus 10 a content list indicating types of content which the server apparatus can transfer to the client apparatus 10 before the server initiates the streaming of the content, as described below. The content list is, for example, stored in the ROM 100e of the control unit 100c. The content list according to the present embodiment includes four types of content such as the original image 301, the medium resolution image 302, the low resolution image 303 and the dynamic alteration image 304. Therefore, the client apparatus 10 specifies one image type included in the content list to request the server apparatus 100 to transfer the specified type of image. The server apparatus 100 generates images according to the specified type and transfers the generated images to the client apparatus 10.

The content database 100b of the server apparatus 100 stores the original images of streaming content in the present embodiment. It is noted that the original image is an image generated according to the settings for the original image as illustrated in FIG. 6. The unit of resolution is dpi (dot per inch) in FIG. 6. In addition, the container means a data form of the data encoded by the server apparatus 100. MPEG2-TS is adopted for the container in the present embodiment. And H.264 is adopted for the VIDEO codec as the encoding and decoding scheme of video data. Since H.264 is a known video compression standard, the detailed descriptions of H.264 are omitted here. Further, AAC (Advanced Audio Coding) is adopted for the AUDIO codec as the encoding and decoding scheme of audio data. It is noted that the container and each codec can be arbitrarily changed to other known standards or schemes.

Further, the server apparatus 100 generates dynamic alteration images based on the original images. It is noted that the dynamic alteration image is an image generated according to the settings of the dynamic alteration image 304 as illustrated in FIG. 6. The server apparatus 100 generates medium resolution images or low resolution images according to the requests from the client apparatus 10. It is also noted that the medium resolution image and the low resolution image are images generated according to the settings of the medium resolution image 302 and the low resolution image as illustrated in FIG. 6, respectively.

The server apparatus 100 generates the medium resolution images 302, the low resolution image 303 and the dynamic alteration images 304 based on the original images in the present embodiment. The image quality of the original image is better than the image qualities of the medium resolution images 302, the low resolution image 303 and the dynamic alteration images 304. As for the image quality of an image displayed at the client apparatus 10, the image quality of the medium resolution image 302 is better than the image quality of the low resolution image 303 as illustrated in FIG. 6. In addition, the server apparatus 100 can change the bit rate for the dynamic alteration image 304 according to an instruction regarding the bit rate from the client apparatus 10. The settings are similar to the settings of the medium resolution image 302 and the low resolution image 303 except that the bit rate for the dynamic alteration image 304 is variable as illustrated in FIG. 6. The details of processes for streaming of the dynamic alteration images 304 are described later.

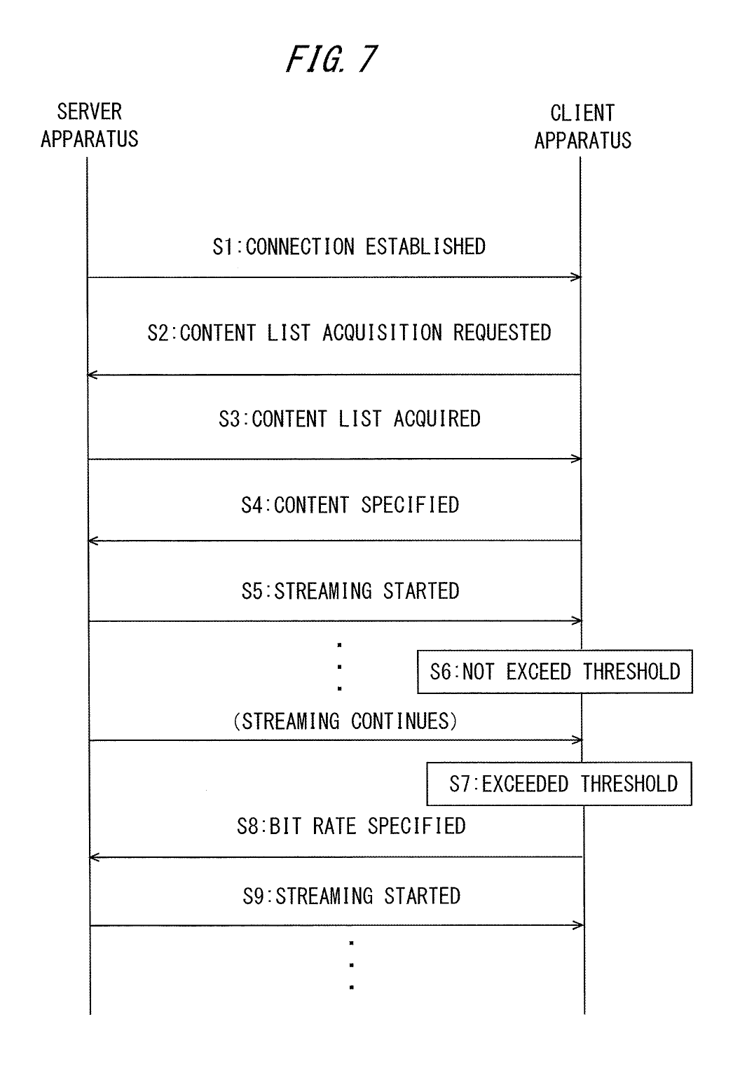

FIG. 7 is a sequence diagram illustrating processes for streaming occurred between the server apparatus 100 and the client apparatus 10. First, the server apparatus 100 establishes a connection with the client apparatus 10 via the network 2 (S1). The client apparatus 10 acquires from a base station (not illustrated) information regarding the term of agreement of the contract with the carrier, information regarding the amount of packet communication within the term of agreement and information regarding the upper limit of the amount of packet communication.

The information regarding the term of agreement of the contract with the carrier is information regarding the starting date and the termination date of the contract. The term of agreement of the contract with the carrier is generally updated every month and the amount of packet communication is returned to zero, which is an initial value, when the contract is renewed. In addition, the information regarding the amount of packet communication within the term of agreement is information regarding the total amount of packet communication which the client apparatus 10 has used until the present date within the term of agreement. It is noted that the client apparatus 10 continually acquires the information regarding the amount of packet communication from a base station even during the streaming of the content. And the information regarding the upper limit of the amount of packet communication is information of the upper limit of the total amount of packet communication allowed for the client apparatus 10, which is set according to the contract by the carrier.

Further, the client apparatus 10 uses the information as described above acquired from the base station to set a threshold which is used as a trigger for initiating processes for decreasing the quality of the streaming content. The client apparatus 10 monitor the amount of packet communication during the streaming and decreases the quality of the streaming content when the client apparatus 10 determines that the total amount of packet information exceeds the threshold. As a result the client apparatus 10 can control the total amount of packet communication not to exceed the upper limit set according to the contract.

Next, the client apparatus 10 requests the server apparatus 100 as a host to transmit a list of streaming content which can be transferred from the server apparatus 10 to the client apparatus 10 (S2). When the server apparatus 100 receives the request from the client apparatus 10, the server apparatus 100 acquires a content list from the ROM 100e and transmits the content list to the client apparatus 10 via the wireless unit 100a. The content list may be a list which contains at least types of images which the server apparatus 100 can generate and bit rates set for encoding the images. And the content list can be transmitted as a text file such as xml file. Therefore, the client apparatus 10 can instruct the server apparatus 100 to generate the original image 301, the medium resolution image 302, the low resolution image 303 and the dynamic alteration image 304. Moreover, the client apparatus 10 can specify the bit rate used for encoding the dynamic alteration image 304 to the server apparatus 100.

The client apparatus 10 acquires the content list from the server apparatus 100 (S3), selects the dynamic alteration image from the content list and specifies the dynamic alteration image as the image used for the streaming to the server apparatus 100. The client apparatus 10 stores the acquired content list in the ROM 10g. In addition, the client apparatus 10 specifies the bit rate for the dynamic alteration image. The bit rate for the dynamic alteration image is variable as described above. As one example in the present embodiment, the server apparatus 100 can specify the bit rate used for encoding the dynamic alteration image from 1 Mbps to 12 Mbps at 1 Mbps intervals. Therefore, the client apparatus 10 can specify 12 Mbps for the bit rate for encoding the dynamic alteration image to the sever apparatus 100 (S4), for example. It is noted that the intervals at which the bit rate for encoding the dynamic alteration image can be specified can arbitrarily defined.

The server apparatus 100 acquires content corresponding to the original image 301 from the content data base 100b when the server apparatus 100 receives a specification regarding the dynamic alteration image and the bit rate from the client apparatus 10. In addition, the server apparatus 100 sets the specified bit rate to the encoder to encode the content acquired from the content database 100b. Further, the server apparatus 100 transmits the encoded content to the client apparatus 10 via the wireless unit 100a. As a result, the server apparatus 100 initiates the streaming of the content specified from the client apparatus 10 (S5).

After the streaming is initiated, the client apparatus 10 determines whether or not the total amount of packet communication within the current term of agreement exceeds the threshold set based on the information acquired from the base station as described above (S6). When the client apparatus 10 determines that the current total amount of packet communication exceeds the threshold (S7), the client apparatus 10 specifies a bit rate lower than the bit rate specified for the dynamic alteration image in S4 to the server apparatus 100 (S8). Then the server apparatus 10 set the bit rate specified in S8 to the encoder. Therefore, the server apparatus 100 can generate streaming content by merely changing the encoding setting for VIDEO codec without ceasing the streaming by performing processes such as HTTP GET (S9).

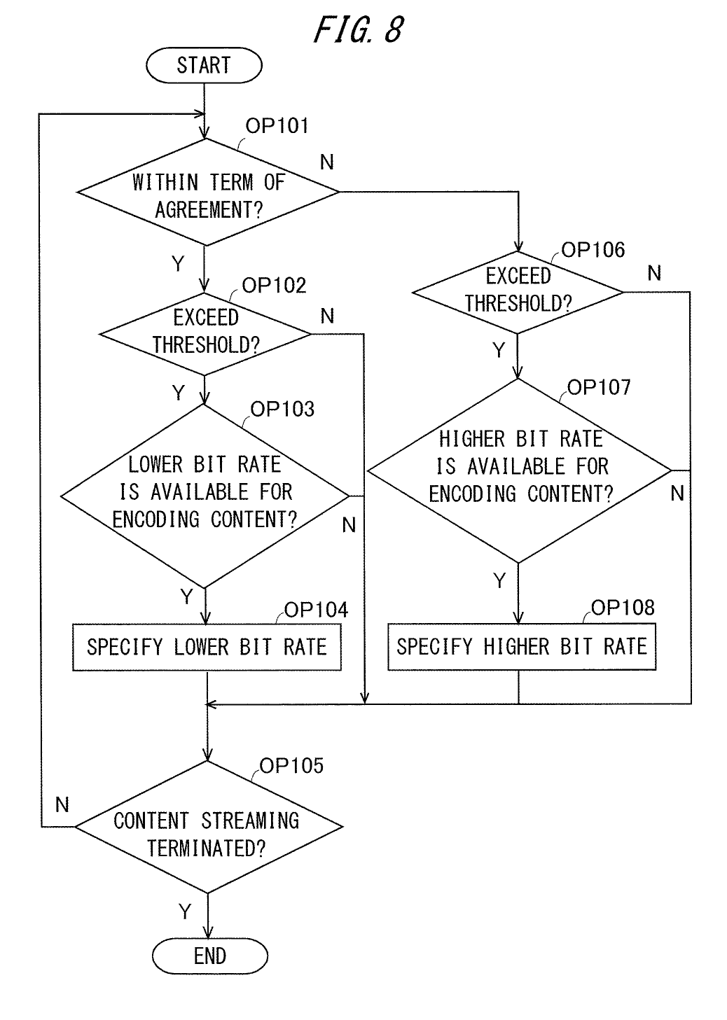

FIG. 8 illustrates a flowchart of processes performed by the client apparatus 10 during the streaming. Each process in the flowchart is performed by the CPU 10f when the client apparatus 10 initiates the streaming. The CPU 10f determines whether or not the current date is within the term of agreement based on the information regarding the term of agreement acquired from the base station (OP101). The CPU 10f acquires the information regarding the current date from a timer (not illustrated) or by using a known technique such as real-time clock. When the CPU 10f determines that the current date is within the term of agreement (OP101: Yes), the CPU 10f progresses the process to OP102. On the other hand, when the CPU 10f determines that the current date is not within the term of agreement (OP101: No), the CPU 10f progresses the process to OP106.

In OP102, the CPU 10f determines whether or not the current total amount of packet communication exceeds the threshold. When the CPU 10 determines that the current total amount of packet communication exceeds the threshold (OP102: Yes), the CPU 10f progresses the process to OP103. On the other hand, the CPU 10f determines that the current total amount of packet communication does not exceed the threshold (OP102: No), the CPU 10f progresses the process to OP105 to continue the current streaming.

In OP103, the CPU 10f refers to the content list acquired from the server apparatus 100 to determine whether or not a bit rate lower than the bit rate specified by the client apparatus 10 in S4 in FIG. 7 before the streaming is initiated can be specified to the server apparatus 100. For example, when 12 Mbps is currently specified to the bit rate for the streaming, the CPU 10f determines a bit rate ranging from 1 Mbps to 11 Mbps at 1 Mbps intervals as a new bit rate. The information of the new bit rate determined by the CPU 10f is transmitted to the server apparatus 100 via the network communication unit 10m and the wireless unit 10p (OP104). Next, the CPU 10f progresses the process to OP105.

In OP105, the CPU 10f determines whether or not the streaming of the current streaming content has been terminated. When the CPU 10f determines that the streaming of the current streaming content has not been terminated (OP105: No), the CPU 10f returns the process to OP101 to perform the determination of the current total amount of packet communication again. In addition, when the CPU 10f determines that the streaming of the current streaming content has been terminated (OP105: Yes), the CPU 10f terminates the process of the present flowchart.

When the CPU 10f determines that the current date is not within the current term of agreement, it can be assumed that the streaming is continuing from the previous term of agreement to the current term of agreement. Therefore, the CPU 10f determines in OP106 whether or not the total amount of packet communication exceeds the threshold used in OP102 at the time of the termination of the term of agreement. When the total amount of packet communication exceeds the threshold, this means that the current streaming has already being performed at a lower bit rate as described above. However, since the new term of agreement has started and the total amount of packet communication has been reset and recalculated, the current total amount of packet communication does not exceed the threshold. Therefore, when the CPU 10f determines that the total amount of packet communication exceeds the threshold (OP106: Yes), the CPU 10f progresses the process to OP107. On the other hand, when the CPU 10f determines that the total amount of packet communication does not exceed the threshold (OP106: No), the CPU 10f progresses the process to OP105 to continue the current streaming.

In OP107, the CPU 10f refers to the content list to determine whether or not a bit rate higher than the bit rate used in the current streaming can be specified to the server apparatus. When the CPU 10f determines that a higher bit rate can be specified (OP107: Yes), for example, the current bit rate is 4 Mbps in the above example, the CPU 10f determines the higher bit rate by selecting one of bit rates ranging from 5 Mbps to 12 Mbps at 1 Mbps intervals. The information regarding the bit rate determined by the CPU 10f is transmitted to the server apparatus 100 via the network communication unit 10m and the wireless unit 10p (OP108). Next, the process is progressed to OP105. On the other hand, when the CPU 10f cannot specify the higher bit rate (OP107: No), the CPU 10f progresses the process to OP105.

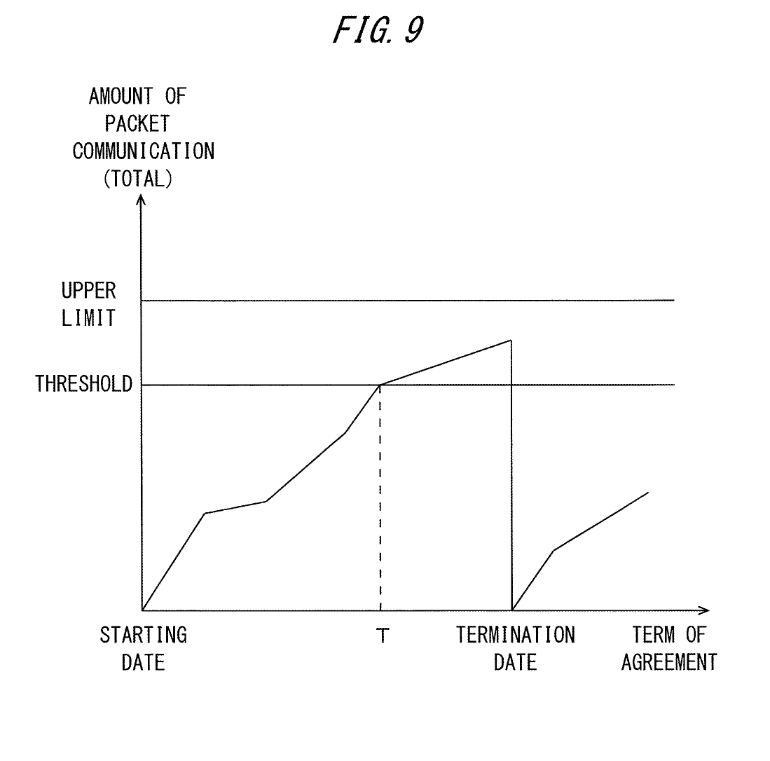

FIG. 9 exemplifies a graph illustrating the relations among the variation of the total amount of packet communication used by the client apparatus 10, a threshold and an upper limit set for the total amount of packet communication in the present embodiment. As illustrated in FIG. 9, the total amount of packet communication starts to increase from the starting date of the term of agreement and exceeds the threshold at the point of time indicated by T before the termination date of the term of agreement. In this case, the client apparatus 10 performs the processes from OP101 to OP104 as described above to specify a bit rate lower than the current bit rate to the server apparatus 100. It is noted that the bit rate specified in OP104 is determined based on the remaining period until the termination date of the contract and the width between the upper limit and the threshold set for the total amount of packet communication. Therefore, the total amount of packet communication varies not to exceed the upper limit until the current streaming is completed.

When the term of agreement terminates and the streaming continues after the termination date, the bit rate which is once decreased in OP104 as described above is increased by the processes of OP101, OP106, OP107 and OP108 to perform the streaming with a better content quality. Therefore, the client apparatus 10 can perform the streaming without having the total amount of packet communication exceed the upper limit set by the contract in the present embodiment. In addition, the client apparatus 10 can continue the streaming without performing processes such as HTTP GET to repeat the acquisition of the streaming content by merely specifying an changed bit rate to the server apparatus 100. Therefore, the client apparatus 10 can avoid problems to cease the streaming in that, for example, a black screen is displayed and sound is not output when the client apparatus 10 instructs the server apparatus 100 to change the bit rate.

Although the present embodiment is described as above, the configurations and the processes of the information processing apparatus are not limited to those as described above and various variations may be made to the embodiment described herein within the technical scope of the above embodiment. For example, the extent to which the client apparatus 10 increases or decreases the bitrate for the dynamic alteration image can be arbitrarily determined according to the amount of packet communication and the term of agreement. Additionally, a variation example of the above embodiment is described below. It is noted that elements corresponding to the elements in the above embodiment are denoted the same marks as above and the detailed descriptions of the elements are omitted in the following descriptions.

### Variation Example 1

The settings of bit rate used for generating dynamic alteration images in the server apparatus 100 are modified based on the variation of the amount of packet communication used by the client apparatus in the above embodiment. On the other hand, the control unit 10a of the client apparatus 10 activates the camera 10c to acquire an image of the face of the user currently using the client apparatus 10 to view the content in the present variation example. And the client apparatus 10 determines whether or not the bit rate for the dynamic alteration image is changed based on the determination of the image recognition unit 10b using the acquired image of the user to determine whether or not the user is currently viewing the content.

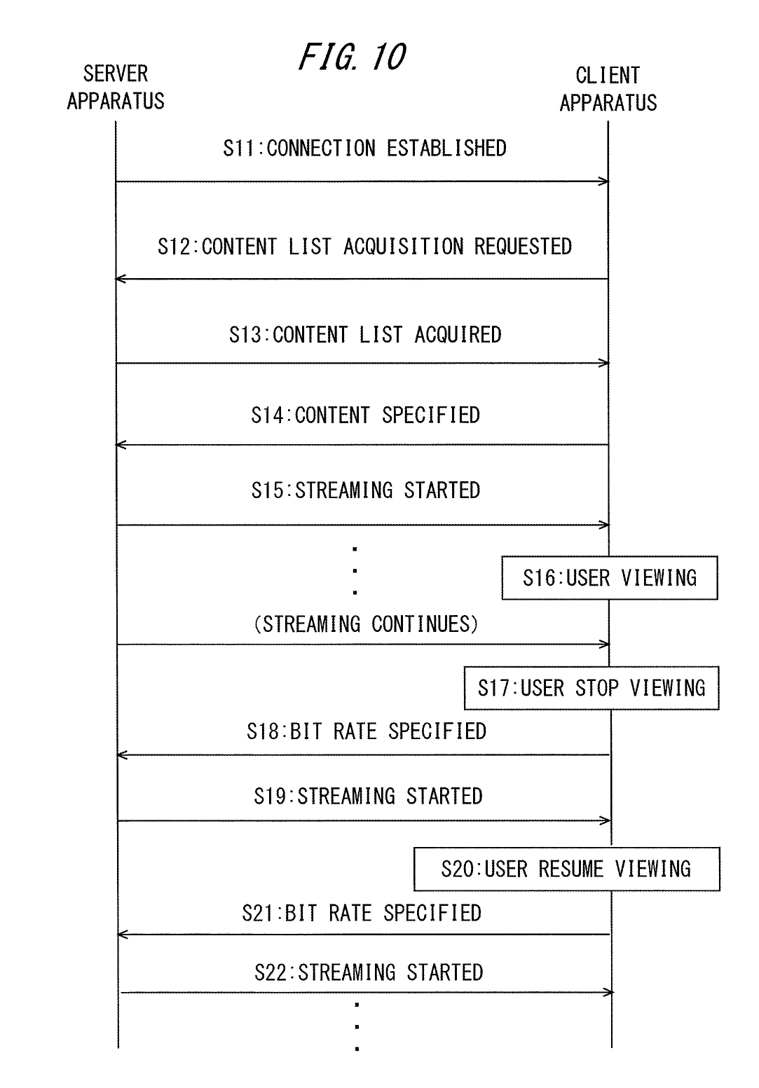

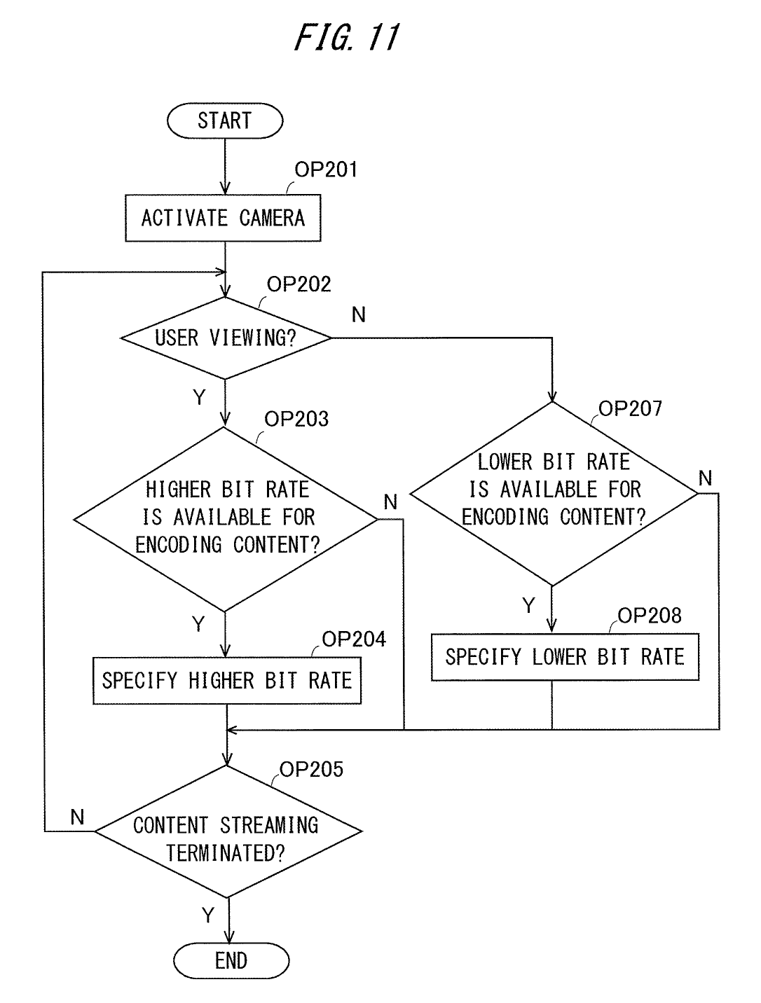

FIG. 10 is a sequence diagram illustrating processes for streaming occurred between the server apparatus 100 and the client apparatus 10 in the present embodiment. Since the processes performed in S11 to S15 are similar to the processes performed in S1 to S5 in FIG. 7, the detailed descriptions of the processes in S11 to S15 are omitted below. In the present variation example, the client apparatus 10 uses the face image of the user viewing the content acquired by the camera 10c to determine whether or not the user is currently viewing the streaming content displayed on the LCD 10d of the client apparatus 10 (S16). The client apparatus 10 specifies a bit rate lower that the current bit rate to the server apparatus 100 when the client apparatus 10 determines that the user is not viewing the content since the user turns away from the LCD 10d or the user moves away from the client apparatus 10, for example. It is noted that the detailed descriptions of the processes in S18 and S19 are omitted here since the processes in S18 and S19 are similar to the processes in S8 and S9 in FIG. 7.

Then, the client apparatus 10 specifies a bit rate higher than the current bit rate to the server apparatus 100 when the client apparatus 10 determines that the user resumes viewing of the content displayed on the LCD 10d. It is noted that the detailed descriptions of the processes in S21 and S22 are omitted here since the processes in S21 and S22 are similar to the processes in S18 and S19.

FIG. 11 illustrates a flowchart of processes performed by the client apparatus 10 during the streaming of the content. Each process in FIG. 11 is performed by the CPU 10f when the client apparatus 10 starts the streaming of the content. In OP201, the CPU 10f activates the camera 10c. And the camera 10c takes an image of the face of the user viewing the content displayed on the LCD 10d. Next, the CPU 10f progresses the process to OP202.

In OP203, the CPU 10f sends the face image of the user acquired from the camera 10c to the image recognition unit 10b. The image recognition unit 10b analyses the acquired face image of the user to determine whether or not the user is currently looking at the LCD 10d, that is, viewing the content displayed on the LCD 10d. The image recognition unit 10b sends the determination result to the CPU 10f. And the CPU 10f determines whether or not the user is currently viewing the content based on the determination result received from the image recognition unit 10b. When the CPU 10f determines that the user is viewing the content (OP202: Yes), the CPU 10f progresses the process to OP203. On the other hand, when the CPU 10f determines that the user is not viewing the content (OP202: No), the CPU 10f progresses the process to OP207.

Since the processes in OP203, OP204, OP205, OP207 and OP208 are similar to the processes in OP107, OP108, OP105, OP103 and OP104, respectively, the detailed descriptions of the processes in OP203, OP204, OP205, OP207 and OP208 are omitted here. As a result of the processes as described above, the server apparatus 100 transfers the content encoded with a bit rate lower than the bit rate used while the user is viewing the content to the client apparatus 10 when the user of the client apparatus 10 is not viewing the streaming content. Therefore, the amount of packet communication can be advantageously reduced while the user is not viewing the streaming content. It is also noted that the client apparatus 10 can continue streaming of the content without a black screen displayed on the LCD 10d and no sound output from the speaker 10e when the bit rate is changed in the present variation example.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

According to one aspect, the client apparatus can avoid the interruption of the displaying of the content even when the type of content transferred to the client apparatus is changed during the streaming of the content.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A content transfer method of transferring content from a server to a client, the content transfer method comprising:
transmitting, by the server, to the client a list indicating a type of content which can be transferred to the client, the list including a type of content in which a bit rate used for encoding the content can be changed within a predetermined range;
encoding, by the server, the content using a bit rate within the predetermined range indicated in the list specified by the client during the transferring of the content to the client, the specified bit rate being used as an upper limit of the bit rate used for encoding the content; and
transferring, by the server, the encoded content to the client.

2. A content transfer apparatus configured to transfer content to a client, comprising:
a processor; and
memory configured to store a program to instruct the processor to perform:
transmitting to the client a list indicating a type of content which can be transferred to the client, the list including a type of content in which a bit rate used for encoding the content can be changed within a predetermined range;
encoding the content using a bit rate within the predetermined range indicated in the list specified by the client during the transferring of the content to the client, the specified bit rate being used as an upper limit of the bit rate used for encoding the content; and
transferring the encoded content to the client.

3. A content receiving apparatus configured to receive content from a server, the content receiving apparatus comprising:
a processor; and
memory configured to store a program to instruct the processor to perform:
receiving from the server a list indicating a type of content which can be transferred to the content receiving apparatus, the list including a type of content in which a bit rate used for encoding the content can be changed within a predetermined range;
specifying a bit rate within the predetermined range indicated in the list to the server during the transferring of the content to the content receiving apparatus; and
receiving from the server the content encoded using the specified bit rate, the specified bit rate being used as an upper limit of the bit rate used for encoding the content.

4. A non-transitory computer-readable recording medium storing a program that causes a computer to execute a process comprising:
transmitting, by the computer, to a client a list indicating a type of content which can be transferred to the client, the list including a type of content in which a bit rate used for encoding the content can be changed within a predetermined range;
encoding, by the computer, the content using a bit rate within the predetermined range indicated in the list specified by the client during the transferring of the content to the client, the specified bit rate being used as an upper limit of the bit rate used for encoding the content; and
transferring, by the computer, the encoded content to the client.
